(19) United States
(12) Patent Application Publication
(10) Pub. No.: US 2026/0152049 A1
(43) Pub. Date: Jun. 4, 2026

(54) Flood Protection Vehicle Covering Device

(71) Applicant: Anthony Agliata, Edison, NJ (US)

(72) Inventor: Anthony Agliata, Edison, NJ (US)

(21) Appl. No.: 19/383,935

(22) Filed: Nov. 10, 2025

Related U.S. Application Data
(60) Provisional application No. 63/726,411, filed on Nov. 29, 2024.

(51) Int. Cl. B60J 11/04

(52) U.S. Cl. CPC B60J 11/04

(57) ABSTRACT

A flood protection vehicle covering device is provided. The device is designed to safeguard vehicles from flood-related damage by forming a sealed, watertight enclosure around the vehicle. The device comprises a body constructed from industrial-grade elastomeric rubber embedded with reinforcing fibers in one embodiment to optimize strength, elasticity, and tear resistance. The inner surface may be lined with a soft composite to protect vehicle finishes, while the bottom wall may integrate a load-bearing substrate and high-friction outer layer for structural support and slip resistance. The body may also be comprised of anchoring features, including corrosion-resistant grommets, adjustable tie-down straps, and ballast pockets, each designed to stabilize the enclosure under flood conditions. Air release valves further enable rapid internal air displacement during sealing.

### CROSS-REFERENCE TO RELATED APPLICATION

The present application claims priority to, and the benefit of, U.S. Provisional Application No. 63/726,411, which was filed on Nov. 29, 2024, and is incorporated herein by reference in its entirety.

### FIELD OF THE INVENTION

The present invention relates generally to the field of vehicle flood protection devices. More specifically, the present invention relates to a device designed to safeguard vehicles from flood-related damage by forming a sealed, watertight enclosure around the vehicle. Accordingly, the present disclosure makes specific reference thereto. Nonetheless, it is to be appreciated that aspects of the present invention are also equally applicable to other like applications, devices, and methods of manufacture.

### BACKGROUND

Flooding events pose a significant threat to vehicles parked in vulnerable areas, particularly in regions prone to severe weather conditions or inadequate drainage infrastructure. During floods, vehicles are frequently exposed to rising water levels, which can infiltrate the engine, electrical systems, and interior components, often resulting in irreparable damage. Once compromised, the cost of repairing or replacing such vehicles can be substantial. Additionally, the time required for insurance processing and claims settlement often leaves vehicle owners without transportation for extended periods. Conventional mitigation measures, such as relocating vehicles to higher ground or using temporary covers, often prove impractical or ineffective, particularly during sudden flood events. Many existing solutions lack a secure sealing mechanism, fail under hydrostatic pressure, or are not designed for variable terrain or different vehicle types. Furthermore, the absence of integrated anchoring or weighting features often results in the displacement of protective coverings during floods, compromising their protective function. This persistent vulnerability has created a demand for a dependable and user-friendly solution that ensures a watertight and immovable enclosure for vehicles during flood exposure.

Therefore, there exists a long-felt need in the art for a flood protection vehicle covering device that prevents water ingress and protects vehicle systems during flood exposure. There also exists a long-felt need in the art for a flood protection vehicle covering device that remains securely in place despite moving water or changing ground conditions. Moreover, there exists a long-felt need in the art for a flood protection vehicle covering device that allows users to easily deploy and seal the enclosure without specialized tools or equipment.

The subject matter disclosed and claimed herein, in one embodiment thereof, comprises a flood protection vehicle covering device. The device is designed to safeguard vehicles from flood-related damage by forming a sealed, watertight enclosure around the vehicle. The device comprises a body constructed from industrial-grade elastomeric rubber embedded with reinforcing fibers in one embodiment to optimize strength, elasticity, and tear resistance. The inner surface may be lined with a soft composite to protect vehicle finishes, while the bottom wall may integrate a load-bearing substrate and high-friction outer layer for structural support and slip resistance. The body may also be comprised of anchoring features, including corrosion-resistant grommets, adjustable tie-down straps, and ballast pockets, each designed to stabilize the enclosure under flood conditions. Air release valves further enable rapid internal air displacement during sealing, and visibility enhancements such as retroreflective strips support deployment in low-light environments. A method of using the device involves spreading the device, positioning the vehicle, enclosing it with the perimeter walls, sealing it with fasteners, evacuating internal air, and securing the body using one or more anchoring mechanisms to maintain stability during flooding.

In this manner, the flood protection vehicle covering device of the present invention accomplishes all the foregoing objectives and provides a fully encapsulating enclosure for protecting a vehicle from flood damage. Further, the device prevents movement during flood conditions using components such as, but not limited to, grommets, integrated tie-down straps, and/or ballast pockets for weighted stabilization. These features collectively allow the user to protect the vehicle effectively, regardless of surface type or flood severity, thereby addressing the unmet need for a reliable, secure, and deployable vehicle protection system in flood-prone areas.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flood protection vehicle covering device designed to shield a vehicle from flood damage by forming a sealed, watertight barrier around the vehicle. The device is comprised of a body that may be reinforced with embedded fibers such as aramid, carbon filaments, or high-tensile polyester mesh, arranged in various patterns to enhance resistance to tearing, puncture, and fatigue. The body is dimensioned to fully encapsulate a vehicle and create a sealed enclosure during use.

To prevent displacement during flood events, the body may include one or more grommets designed to receive fasteners such as ground stakes or anchor bolts. The body may also or alternatively include integrated tie-down straps. In environments without available anchoring points, the body may include at least one ballast pocket designed to receive weight in the form of sand, water, gravel, or pre-formed ballast modules.

The inner surface of the body is comprised of a soft microfiber-felt composite or similar cushioning material to protect vehicle surfaces such as paint, glass, and trim from damage during use. To manage internal air volume, the body may be equipped with at least one air release designed to release air automatically when internal pressure exceeds a threshold. Some valves may include a visual indicator to confirm sufficient air displacement.

Deployment of the device involves laying the body flat, positioning the vehicle atop the base section, and drawing the body over the vehicle. Sealing of the body is accomplished using at least one waterproof fastener. The bottom wall of the body may include a reinforced, load-bearing substrate with an outer layer with a high-friction texture that may be bonded to the underside to prevent slippage.

The invention is further comprised of a method for using the device. The method includes providing the device, laying the body on a ground surface, positioning the vehicle, enclosing the vehicle by lifting the perimeter walls, sealing the body with a fastener, and stabilizing the body using anchoring or ballast mechanisms. The release valve allows internal air to escape during sealing, ensuring proper fit and structural integrity during flood exposure.

Accordingly, the flood protection vehicle covering device of the present invention is particularly advantageous as it provides a fully encapsulating enclosure for protecting a vehicle from flood damage. Further, the device prevents movement during flood conditions using components such as, but not limited to, grommets, integrated tie-down straps, and/or ballast pockets for weighted stabilization. These features collectively allow the user to protect the vehicle effectively, regardless of surface type or flood severity, thereby addressing the unmet need for a reliable, secure, and deployable vehicle protection system in flood-prone areas.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a flood protection vehicle covering device of the present invention while sealed around a vehicle in accordance with the disclosed architecture;

FIG. 2 illustrates a perspective view of one potential embodiment of a flood protection vehicle covering device of the present invention while a vehicle is on top of the body and the body is not drawn around a vehicle in accordance with the disclosed architecture; and

FIG. 3 illustrates a flowchart of a method of using one potential embodiment of a flood protection vehicle covering device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, therefore, there exists a long-felt need in the art for a flood protection vehicle covering device that prevents water ingress and protects vehicle systems during flood exposure. There also exists a long-felt need in the art for a flood protection vehicle covering device that remains securely in place despite moving water or changing ground conditions. Moreover, there exists a long-felt need in the art for a flood protection vehicle covering device that allows users to easily deploy and seal the enclosure without specialized tools or equipment.

The present invention, in one exemplary embodiment, is comprised of a flood protection vehicle covering device that shields a vehicle from flood damage by forming a sealed, watertight barrier around the vehicle. The device comprises a body that may be reinforced with embedded fibers such as aramid, carbon filaments, or high-tensile polyester mesh arranged in various configurations to improve resistance to tearing, puncture, and fatigue. The body is dimensioned to fully enclose a vehicle and form a sealed enclosure during operation. To minimize displacement during flood conditions, the body may feature one or more grommets configured to receive fasteners like ground stakes or anchor bolts and may also or alternatively incorporate integrated tie-down straps. In areas lacking fixed anchoring points, at least one ballast pocket may be included to hold sand, water, gravel, or pre-formed ballast modules.

The inner surface of the body comprises a soft microfiber-felt composite or equivalent cushioning layer to safeguard vehicle surfaces, including paint, glass, and trim. To manage internal air volume, the body may incorporate at least one air release valve that automatically expels air when internal pressure surpasses a set threshold, with some valves featuring a visual indicator to confirm air displacement. Deployment involves laying the body flat, positioning the vehicle atop the base, and drawing the body over the vehicle. Sealing is completed using at least one waterproof fastener, while the bottom wall may include a reinforced load-bearing substrate with a high-friction outer surface to prevent slippage.

The invention further comprises a method of use involving device placement, vehicle positioning, perimeter wall lifting, sealing, and stabilization using anchoring or ballast elements, wherein the release valve facilitates internal air escape during sealing to ensure structural integrity and proper fit. Accordingly, the flood protection vehicle covering device offers a fully encapsulating enclosure that safeguards vehicles from flood damage and remains stable using grommets, tie-down straps, and ballast pockets, delivering a dependable solution for vehicle protection across varying surfaces and flood conditions.

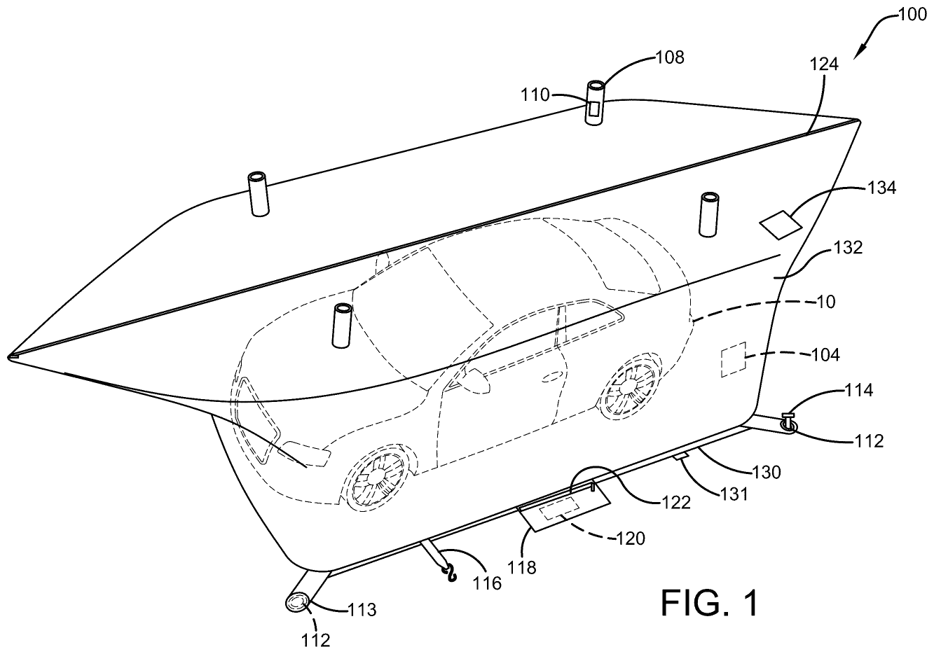

Referring initially to the drawings, FIG. 1 illustrates a perspective view of one potential embodiment of a flood protection vehicle covering device 100 of the present invention while sealed around a vehicle in accordance with the disclosed architecture. The flood protection vehicle covering device 100 is an enclosure engineered to protect a vehicle 10 from flood-related damage by creating a sealed barrier around a vehicle 10. However, in other embodiments the device 100 may be used to enclose/cover any items, object, structure, etc. The device 100 is comprised of a body 102, which is preferably made from an industrial-grade elastomeric rubber material selected for its strength, elasticity, and environmental resilience. The material of the body 102 is designed to endure extensive exposure to water and mechanical stress without losing flexibility or structural integrity. The body 102 material is preferably waterproof. To further reinforce the material against physical strain, the body 102 may be embedded with fibers 104 (as seen in FIG. 1), such as, but not limited to, aramid fibers for high tensile strength, carbon filaments for low weight and rigidity, high-tensile polyester mesh for enhanced flexibility, or combinations thereof. The embedded fibers 104 may be arranged in any pattern such as, but not limited to, cross-hatched, unidirectional, or multi-layered mesh patterns to optimize durability and resistance to tearing, punctures, or fatigue from repetitive flexing or folding during deployment and storage. During operation, the body 102 is dimensioned and shaped to fully surround and encapsulate a vehicle 40, forming a watertight enclosure once sealed.

To prevent displacement during flood events characterized by rapidly moving water or surge activity, the body 102 may include an anchoring mechanism such as at least one grommet 112, as seen in FIG. 1. Each grommet 112 is designed to accept at least one fastener 114, such as, but not limited to, a ground stake, an anchor bolt, a tie-down hook, etc. The grommets 112 are preferably made from corrosion-resistant metal such as stainless steel, brass, or zinc-alloy and may be further reinforced with surrounding thermoplastic overlays 113 to distribute mechanical load and resist tearing at anchor points.

Additionally or alternatively, the body 102 may be equipped with integrated tie-down straps 116, as seen in FIG. 1. The straps 116 may be manufactured from UV-stabilized woven nylon, polyester webbing, or thermoplastic elastomer blends. The straps 116 may be any type of strap such as, but not limited to, ratcheting straps, cam buckle straps, hook and loop straps, quick release straps, adjustable straps, elastic straps, swivel-end straps, loop-end straps, etc.

In situations where no fixed anchoring point is available, such as deployments in paved lots or temporary locations, the body 102 may include at least one ballast pocket 118, as seen in FIG. 1. Each ballast pocket 118 is configured to receive weight 120 in the form of water, sand, gravel, or a pre-formed ballast module. The pockets 118 may vary in shape, including rectangular, cylindrical, or wedge-shaped cavities, depending on intended fill material and desired weight distribution. The pockets 118 are preferably constructed from durable, flexible, waterproof materials such as multi-ply PVC, polyurethane-coated fabric, or rubberized textiles. The pockets 118 may be further comprised of welded/ultrasonic seams 120 to prevent leakage and improve seam life under hydrostatic pressure or mechanical flexing. Closure of the ballast pockets 118 may be achieved using fasteners 122 such as, but not limited to, watertight roll-top seals, waterproof zippers, quick-lock sliders, hook-and-loop flaps, or threaded caps with gasketed interfaces, allowing for easy refilling, drainage, and cleaning.

The inner surface 106 of the body 102, which contacts the exterior surface 12 of the vehicle 10, is preferably made from a soft microfiber-felt composite or equivalent cushioning material. This material is designed to protect painted surfaces, glass, chrome, or plastic trim from scratches, marring, or pressure points during enclosure.

To manage internal air volume and ensure proper fit, the body 102 may be comprised of at least one air release valve 108, preferably positioned along the top surface of the body 102 as seen in FIG. 1. The valves 108 may be any type of valve such as, but not limited to, a spring-loaded valve, diaphragm-controlled valve, or mechanically actuated valve and are configured to open automatically when internal air pressure within the body 102 exceeds a calibrated threshold. As a result, the valve 108 allows for rapid air evacuation during the sealing process, preventing ballooning or uneven tension within the body 102. In one embodiment, each valve 108 may also include a color-coded air displacement indicator 110 that indicates whether air has been sufficiently expelled.

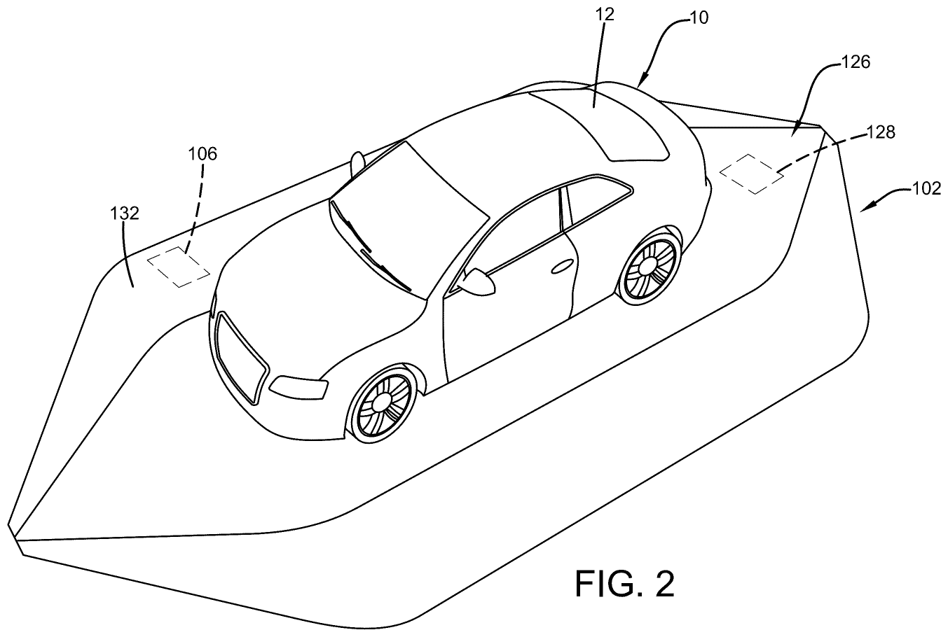

To deploy the flood protection vehicle covering device 100, a user first spreads the body 102 flat on the ground and drives the vehicle 10 into position atop the base section, as seen in FIG. 2. The perimeter walls of the body 102 are then manually or mechanically lifted and drawn over the sides and top of the vehicle 10. Closure is achieved using at least one fastener 124, which may be a heavy-duty waterproof zipper constructed from molded polymer, coated metal, or composite materials. The zipper may include interlocking teeth with high-pull strength and corrosion resistance and may feature dual-slider heads to permit bidirectional closure. In some configurations, the zipper may be protected by an external storm flap or magnetic cover to further enhance water resistance. The sealing path may be aligned longitudinally along the roofline or diagonally across the vehicle to accommodate various vehicle geometries and improve ergonomics during deployment.

The bottom wall 126 of the body 102 may be a reinforced layer comprising a load-bearing inner substrate 128 capable of supporting the full weight of the vehicle 10 without compression damage or deformation, as seen in FIG. 2. Suitable materials for the substrate 128 include, but are not limited to, woven ballistic nylon, high-density polyethylene (HDPE), or cross-laminated thermoplastic composites. The bottom wall 126 may also be comprised of an outer layer 130 with a high-friction texture that may be bonded to the underside to provide slip resistance during vehicle 10 entry, exit or in the presence of standing water. The outer layer 130 may be comprised of a grip-enhancing feature 131 such as, but not limited to, tread-like grooves, rubberized coatings, and/or abrasive textures to enhance traction and prevent displacement on smooth or inclined surfaces.

To improve operational visibility and enable deployment under reduced lighting conditions, the outer surface 132 of the body 102 may incorporate visibility enhancement features 134. These features 134 may include, but are not limited to, retroreflective strips made from high-intensity prismatic materials or glass-bead tape, configured in vertical, horizontal, chevron, or any other patterns for maximum reflectivity.

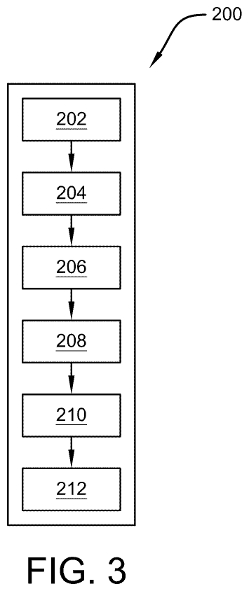

The present invention is also comprised of a method of using 200 the flood protection vehicle covering device 100, as seen in FIG. 3. First, a flood protection vehicle covering device 100 is provided, comprised of a body 102, at least one fastener 124, at least one release valve 108, and at least one anchoring or ballast mechanism, such as a grommet 112, tie-down strap 116, or ballast pocket 118 [Step 202]. Then, the body 102 is laid flat on a suitable ground surface, such as a driveway, parking area, or garage floor, ensuring that the base section is unobstructed and the material is fully spread out [Step 204]. Next, a vehicle 10 is driven into position and centered atop the base section of the body 102, ensuring that all four wheels are aligned within the designated encapsulation area [Step 206]. Once the vehicle 10 is properly positioned, the perimeter walls of the body 102 are lifted and drawn upward and over the sides and top of the vehicle 10 until the vehicle 10 is fully enclosed by the body 102 [Step 208]. After the body 102 has been positioned around the vehicle 10, the fastener 124 is used to seal the body 102 around the vehicle 10 [Step 210]. As the body 102 is sealed, at least one release valve 108 allows trapped air to escape from the interior of the enclosure. Once the enclosure is sealed and internal air has been displaced, the body 102 is stabilized. This may include securing at least one fastener 114 through the grommet 112 to a fixed anchor, tensioning the tie-down straps 116 to a stable structure, and/or filling the ballast pockets 118 with water, sand, or gravel to prevent movement during flood exposure [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “flood protection vehicle covering device” and “device” are interchangeable and refer to the flood protection vehicle covering device 100 of the present invention.

Notwithstanding the foregoing, the flood protection vehicle covering device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the flood protection vehicle covering device 100 as shown in the FIGS. are for illustrative purposes only, and that many other sizes and shapes of the flood protection vehicle covering device 100 are well within the scope of the present disclosure. Although the dimensions of the flood protection vehicle covering device 100 are important design parameters for user convenience, the flood protection vehicle covering device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flood protection vehicle covering device comprising:
a body that forms a watertight enclosure around a vehicle;
an air release valve disposed on the body; and
a fastener configured to seal the body around the vehicle.

2. The flood protection vehicle covering device of claim 1, wherein the air release valve comprises a spring-loaded valve, a diaphragm-controlled valve, or a mechanically actuated valve.

3. The flood protection vehicle covering device of claim 1, wherein the air release valve is comprised of a color-coded air displacement indicator.

4. The flood protection vehicle covering device of claim 1, wherein the fastener is comprised of a waterproof zipper.

5. The flood protection vehicle covering device of claim 1, wherein the body is comprised of an inner surface comprised of a micro-felt composite.

6. The flood protection vehicle covering device of claim 1, wherein the body is comprised of a grommet.

7. The flood protection vehicle covering device of claim 1, wherein the body is comprised of a tie-down strap.

8. The flood protection vehicle covering device of claim 1, wherein the body is comprised of a ballast pocket.

9. The flood protection vehicle covering device of claim 8, wherein the ballast pocket is comprised of a weight.

10. A flood protection vehicle covering device comprising:
a body comprised of a waterproof material that forms a watertight enclosure around a vehicle, the body comprised of an embedded fiber and a bottom wall comprised of an outer layer comprised of a grip-enhancing feature;
an air release valve disposed on the body; and
a fastener configured to seal the body around the vehicle.

11. The flood protection vehicle covering device of claim 10, wherein the body is comprised of a grommet.

12. The flood protection vehicle covering device of claim 10, wherein the body is comprised of a tie-down strap.

13. The flood protection vehicle covering device of claim 10, wherein the body is comprised of a ballast pocket.

14. The flood protection vehicle covering device of claim 10, wherein the ballast pocket is comprised of a weight.

15. The flood protection vehicle covering device of claim 10, wherein the embedded fiber is arranged in a cross-hatched, unidirectional, or multi-layered mesh pattern.

16. The flood protection vehicle covering device of claim 10, wherein the embedded fiber is comprised of an aramid fiber, a carbon filament, or a polyester mesh.

17. The flood protection vehicle covering device of claim 10, wherein the air release valve comprises a spring-loaded valve, a diaphragm-controlled valve, or a mechanically actuated valve.

18. The flood protection vehicle covering device of claim 10, wherein the air release valve is comprised of a color-coded air displacement indicator.

19. The flood protection vehicle covering device of claim 10, wherein the grip-enhancing feature is comprised of a groove, a rubberized coating, or an abrasive texture.

20. A method of using a flood protection vehicle covering device, the method comprising the following steps:
providing a flood protection vehicle covering device comprised of providing a flood protection vehicle covering device comprising a body, a fastener, an air release valve, and an anchoring mechanism or a ballast mechanism;
laying the body flat on a ground surface;
driving a vehicle onto the body;
lifting and drawing the body over the vehicle to fully enclose the vehicle within the body;
sealing the body around the vehicle using the fastener; and
stabilizing the sealed body using an anchoring mechanism or ballast mechanism.
